(19) United States
(12) Patent Application Publication
(10) Pub. No.: US 2024/0008630 A1
(43) Pub. Date: Jan. 11, 2024

(54) Cleaning Brush Device

(71) Applicant: Thomas Lewis, Perris, CA (US)

(72) Inventor: Thomas Lewis, Perris, CA (US)

(21) Appl. No.: 18/186,450

(22) Filed: Mar. 20, 2023

Related U.S. Application Data
(60) Provisional application No. 63/358,993, filed on Jul. 7, 2022.

(51) Int. Cl. A46B 5/00; A46D 3/00; A46B 9/00; A46B 15/00; B08B 1/00; B60S 3/00

(52) U.S. Cl. CPC A46B 5/0016; A46D 3/00; A46B 5/0095; A46B 9/005; A46B 5/005; A46B 15/0085; B08B 1/002; B60S 3/008; A46B 2200/3046; A46B 2200/3086

(57) ABSTRACT

The present invention relates to a novel cleaning brush device. The device is a handheld brush device for cleaning crevices, between vehicle seats, floor surfaces and other tight spaces. The cleaning brush device comprises a handle component with two brush components, wherein one brush component is secured to opposite ends of the handle component. The brush components can be flexible with durable bristles for cleaning different tight and/or small areas. Thus, the cleaning brush device effectively removes bacteria, dust, dirt, debris, mold, mildew, etc.

### CROSS-REFERENCE TO RELATED APPLICATION

The present application claims priority to, and the benefit of, U.S. Provisional Application No. 63/358,993, which was filed on Jul. 7, 2022, and is incorporated herein by reference in its entirety.

### FIELD OF THE INVENTION

The present invention relates generally to the field of cleaning brush devices. More specifically, the present invention relates to an improved cleaning brush device that provides users with a crevice brush for removing dust, dirt, and debris from between and around vehicle seats, floor surfaces, etc. Accordingly, the present disclosure makes specific reference thereto. Nonetheless, it is to be appreciated that aspects of the present invention are also equally applicable to other like applications, devices, and methods of manufacture.

### BACKGROUND

By way of background, this invention relates to improvements in cleaning brush devices. Cleaning crevices and other hard to reach areas with standard cleaning brushes can be difficult and frustrating. The brush head may not fit properly within a specific area, and people may abandon trying to clean that area. Further, the buildup of dirt, dust, debris, mold, and mildew can cause odors which can be difficult to remove. Additionally, the buildup of dirt, dust, debris, mold, and mildew will detract from the aesthetics of the vehicle interior.

Thus, it is necessary for users to have a cleaning brush for cleaning crevices between vehicle seats, floor surfaces, and other tight spaces. Notwithstanding previous efforts to construct a cleaning brush for use on vehicle interiors, such as seats, floors, small spaces, etc., there remains a need in the art for a cleaning brush that allows users to easily clean crevices between vehicle seats and other tight spaces with ease. Further, there is a need in the art for a cleaning brush that removes bacteria, dust, dirt, debris, mold, mildew, etc.

Therefore, there exists a long-felt need in the art for a cleaning brush device that provides users with a crevice brush for removing dust, dirt, and debris from between and around vehicle seats, floor surfaces, etc. There is also a long-felt need in the art for a cleaning brush device that features a comfortable gripping handle attached to two independent brush ends. Further, there is a long-felt need in the art for a cleaning brush device that allows users to easily clean crevices, between vehicle seats, and other tight spaces with ease. Moreover, there is a long-felt need in the art for a device that prevents excessive odors from developing due to unclean areas. Further, there is a long-felt need in the art for a cleaning brush device wherein the two independent brush ends comprise flexible, durable bristles for cleaning different areas. Finally, there is a long-felt need in the art for a cleaning brush device that effectively removes bacteria, dust, dirt, debris, mold, mildew, etc.

The subject matter disclosed and claimed herein, in one embodiment thereof, comprises a cleaning brush device. The device is a handheld brush device for cleaning crevices, between vehicle seats, floor surfaces and other tight spaces. The cleaning brush device comprises a handle component with two brush components, wherein one brush component is secured to opposite ends of the handle component. The brush components can be flexible with durable bristles for cleaning different tight and/or small areas. Thus, the cleaning brush device effectively removes bacteria, dust, dirt, debris, mold, mildew, etc.

In this manner, the cleaning brush device of the present invention accomplishes all of the foregoing objectives and provides users with a device that is used to clean a vehicle floor, as well as to clean crevices and/or other tight spots within the vehicle. The device provides users with a tool that can be held securely via the handle while in use cleaning the vehicle interior. The device can be used to remove dust and dirt from between and around vehicle seats, floor surfaces, etc.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a cleaning brush device. The device is a handheld brush device for cleaning crevices, between vehicle seats, floor surfaces and other tight spaces. The cleaning brush device comprises a handle component with two brush components, wherein one brush component is secured to opposite ends of the handle component. The brush components can be flexible with a plurality of durable bristles for cleaning different tight and/or small areas. Thus, the cleaning brush device effectively removes bacteria, dust, dirt, debris, mold, mildew, etc.

In one embodiment, the cleaning brush device includes a handle component and a brush component with a bristle portion. The handle component may be manufactured of molded plastic material, wood, metal, etc., or any other suitable material as is known in the art.

In another embodiment, the brush component comprises a stiff member, typically a coil spring, that is tightly wound into a small diameter-wire spring with considerable flexibility. This keeps the portion of the brush component close to the handle component as stiff as possible, thereby giving the brush component the required firmness. In another embodiment, the stiff member can also comprise a rigid member which extends axially within the coil spring concentric therewith and fixed within the handle component. The end of the rigid member is spaced from the end of the coil spring to thereby limit the flexibility of the brush component to the portion between the bristle portion and the end of the stiff member.

In another embodiment, the stiff member may be manufactured of a twisted pair of wires. In the manufacture thereof, a portion of the twisted wires can be used for mounting a plurality of bristles on the bristle portion. The twisted wires can then be secured directly to the handle component.

In another embodiment, the stiff member can be a standard metal component such that the brush component comprises very little to no flexibility.

In the manufacture of the cleaning brush device, the stiff member (i.e., coil spring) is wound with a high initial tension to give it reasonable stiffness. The coil spring is cut to an average length of 11 inches with an outside diameter of ¼ inch. The bristle portion is mounted in the conventional way at the time of twisting the wires, such as via gluing, adhesive, etc. After the plurality of bristles are twisted with the wires, the plurality of bristles are trimmed to approximately ⅝-inch diameter. The brush portion is then approximately 1-3 inches long and is inserted into the end of the handle component. The brush portion, including the twisted wires and the plurality of bristles, may be fixed to the end of the handle component by crimping or by glue, etc., or any other suitable securing means as is known in the art.

In one embodiment, the stiff member normally extends outwardly from the handle component a short distance. If a molded plastic handle component is used, the stiff member of the brush component is heated and then pressed into the end of the handle component whereby it will melt the plastic and then solidify by cooling. If a wooden handle component is used, then the brush component may be placed therein and secured with glue or any other securing means as is known in the art to the end of the handle component.

In another embodiment, the bristly portion comprises a plurality of durable bristles. The bristles can be manufactured of any suitable material as is known in the art, such as nylon, plastic, hair, etc. The plurality of bristles would be secured to the bristle component via crimping, gluing, adhesive, etc. The bristle component is then secured to the stiff member of the brush component via gluing, adhesive, screwing, etc. The brush component is then secured to the handle component via gluing, adhesive, screwing, etc.

In another embodiment, the brush components are releasably secured to the handle component, via screws, pins, etc. A user can remove and replace the brush components with new brush components when worn out or replace the brush components with additional cleaning implements.

In one embodiment, the user can replace a brush component with a foam brush component. A foam brush component may be constructed of thermoplastics such as polyurethane foam or styrene, or may be constructed of a composite of polyester and polyurethane. It is only important that it be in the form of a foam material for absorbing fluid for the cleaning procedure and be flexible and pliable to conform to the various radii of curvature for various rounded or sharp-edged crevices. Such cleaning brush is generally conically shaped to taper distally and inwardly from its base toward its reduced in diameter tip. The foam is preferably formed on one lateral side with a generally rounded cross-sectional configuration to form a rounded surface and on the opposite side with a triangular shape terminating in a point to thus cooperate in providing somewhat of a tear drop cross-sectional shape. This facilitates cleaning of rounded openings and crevices by the surface and cleaning of sharper, pointed, or triangular sections by the point.

In another embodiment, the user can replace a brush component with a polishing component. The polishing component is constructed of absorbent fiber material such as terrycloth, chamois, cotton, etc., and is configured with a generally conical shape to compliment the shape of the brush and is configured to form a close-fit relationship therewith so as to hold the polishing component in position on the handle component and prevent all around rotation relative to the polishing component during the polishing procedure. Any other suitable brush components can be utilized as is known in the art.

In one embodiment, the handle component comprises a telescoping body that can be extended or shortened in length as needed. Further, in this embodiment, the telescoping body can also be bent at various angles, as needed. Additionally, the brush component can be adjustable and able to be bent at angles, as well.

In one embodiment, the cleaning brush device of the present invention may be sold individually or in kit with multiple interchangeable brush head components. Each brush head component would be utilized for cleaning different surfaces and/or sizes of crevices, openings, and small spaces within the vehicle interior.

From the foregoing, it will be apparent to those skilled in the art that the cleaning brush device of the present invention is of relatively inexpensive construction and provides for convenient access to nearly all openings, surfaces, and crevices of vehicle interiors for thorough and complete cleaning and detailing thereof.

In yet another embodiment, the cleaning brush device comprises a plurality of indicia.

In yet another embodiment, a method of cleaning crevices and other hard-to-reach areas within a vehicle is described. The method includes the steps of providing a cleaning brush device comprising a handle component with a brush component secured to opposite ends of the handle component. The method also comprises grasping the cleaning brush device by the handle component, such that the device is securely held in a user's hand. Further, the method comprises inserting one of the brush components into a desired area, such as a vehicle crevice, floor surface, or other tight area. The method also comprises, moving the bristles of the brush component back and forth, as well as up and down to clean the desired area. Finally, removing the cleaning brush component from the desired area and repeating the steps to clean additional areas within the vehicle.

Numerous benefits and advantages of this invention will become apparent to those skilled in the art to which it pertains, upon reading and understanding the following detailed specification.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one embodiment of the cleaning brush device of the present invention in accordance with the disclosed architecture;

FIG. 2 illustrates a perspective view of one embodiment of the cleaning brush device of the present invention wherein the device is shown at a different angle in accordance with the disclosed architecture;

FIGS. 3A-B illustrate a perspective view of one embodiment of the cleaning brush device of the present invention as held in a user's hand in accordance with the disclosed architecture;

FIG. 4 illustrates a perspective view of one embodiment of the cleaning brush device of the present invention in use to clean a vehicle's floor in accordance with the disclosed architecture;

FIG. 5 illustrates a perspective view of one embodiment of the cleaning brush device of the present invention in use to clean crevices inside the vehicle in accordance with the disclosed architecture; and

FIG. 6 illustrates a flowchart showing the method of cleaning crevices and other hard-to-reach areas within a vehicle in accordance with the disclosed architecture.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there is a long-felt need in the art for a cleaning brush device that provides users with a crevice brush for removing dust, dirt, and debris from between and around vehicle seats, floor surfaces, etc. There is also a long-felt need in the art for a cleaning brush device that features a comfortable gripping handle attached to two independent brush ends. Further, there is a long-felt need in the art for a cleaning brush device that allows users to easily clean crevices, between vehicle seats, and other tight spaces with ease. Moreover, there is a long-felt need in the art for a device that prevents excessive odors from developing due to unclean areas. Further, there is a long-felt need in the art for a cleaning brush device wherein the two independent brush ends comprise flexible, durable bristles for cleaning different areas. Finally, there is a long-felt need in the art for a cleaning brush device that effectively removes bacteria, dust, dirt, debris, mold, mildew, etc.

The present invention, in one exemplary embodiment, is a novel cleaning brush device. The device is a handheld brush device for cleaning crevices, between vehicle seats, floor surfaces and other tight spaces. The cleaning brush device comprises a handle component with two brush components, wherein one brush component is secured to opposite ends of the handle component. The brush components can be flexible with durable bristles for cleaning different tight and/or small areas. The present invention also includes a novel method of cleaning crevices and other hard-to-reach areas within a vehicle. The method includes the steps of providing a cleaning brush device comprising a handle component with a brush component secured to opposite ends of the handle component. The method also comprises grasping the cleaning brush device by the handle component, such that the device is securely held in a user's hand. Further, the method comprises inserting one of the brush components into a desired area, such as a vehicle crevice, floor surface, or other tight area. The method also comprises, moving the bristles of the brush component back and forth, as well as up and down to clean the desired area. Finally, removing the cleaning brush component from the desired area and repeating the steps to clean additional areas within the vehicle.

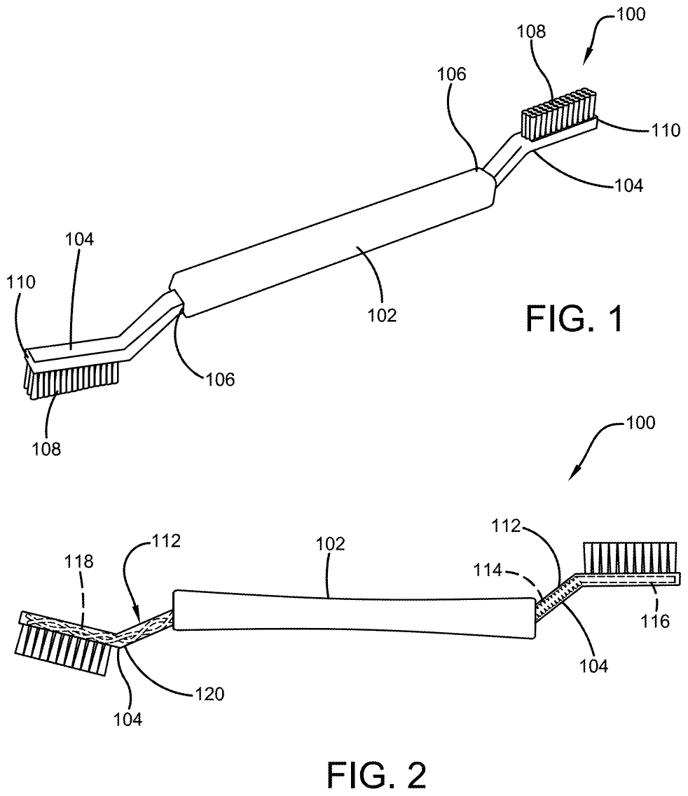

Referring initially to the drawings, FIG. 1 illustrates a perspective view of one embodiment of the cleaning brush device 100 of the present invention. In the present embodiment, the cleaning brush device 100 is an improved cleaning brush device that effectively removes bacteria, dust, dirt, debris, mold, mildew, etc. The cleaning brush device 100 further comprises a handle component 102 with two brush components 104, wherein one brush component 104 is secured to opposite ends 106 of the handle component 102. The cleaning brush device 100 is designed for cleaning crevices, between vehicle seats, floor surfaces and other tight spaces. The brush components 104 of the device 100 can be flexible with a plurality of durable bristles 108 for cleaning different tight and/or small areas within a vehicle interior.

As shown in FIG. 2, the cleaning brush device 100 includes a handle component 102 and a brush component 104 with a bristle portion 110. The handle component 102 may be manufactured of molded heat-sealable plastic or polymers, such as polypropylene or acrylonitrile-butadiene-styrene (ABS), or any other suitable material as is known in the art, such as, but not limited to, acrylic, polycarbonate, polyethylene, thermoplastic, polyethylene terephthalate, polyvinyl chloride, polystyrene, powdered-coated metals, wood, etc. Generally, the cleaning brush device 100 is also manufactured from a material that is water resistant or waterproof, or the handle component 102 comprises a coating that is water resistant or waterproof.

Furthermore, the brush component 104 comprises a stiff member 112, typically a coil spring 114, that is tightly wound into a small diameter-wire spring with considerable flexibility. This keeps the portion of the brush component 104 close to the handle component 102 as stiff as possible, thereby giving the brush component 104 the required firmness. In another embodiment, the stiff member 112 can also comprise a rigid member 116 which extends axially within the coil spring 114 concentric therewith and fixed within the handle component 102. The end of the rigid member 116 is spaced from the end of the coil spring 114 to thereby limit the flexibility of the brush component 104 to the portion between the bristle portion 110 and the end of the stiff member 112.

In another embodiment, the stiff member 112 may be manufactured of a twisted pair of wires 118. In the manufacture thereof, a portion of the twisted wires 118 can be used for mounting a plurality of bristles 108 on the bristle portion 110. The twisted wires 118 can then be secured directly to the handle component 102. Any number of wires can be twisted together to form a stiff member 112 of desired diameter, depending on the needs and/or wants of a user. Further, the wires 118 twisted together can be of any desired tensile strength, allowing for varying degrees of flexibility for the brush component 104.

In another embodiment, the stiff member 112 can be a standard metal component 120, such that the brush component 104 is stiff and comprises very little to no flexibility. Further, any suitable material can be utilized for the stiff member 112, depending on the wants and/or needs of a user and depending on how much flexibility the user desires for the brush components 104.

In the manufacture of the cleaning brush device 100, the stiff member 112 (i.e., coil spring 114) is wound with a high initial tension to give it reasonable stiffness. The coil spring 114 is cut to an average length of approximately 11 inches with an outside diameter of approximately ¼ inch. The bristle portion 110 is mounted in the conventional way at the time of twisting the wires, such as via gluing, adhesive, etc. After the plurality of bristles 108 are twisted with the wires, the plurality of bristles 108 are trimmed to approximately ⅝-inch diameter. The brush component 104 is then approximately 1-3 inches long and is inserted into the end 106 of the handle component 102. The brush component 104, including the twisted wires and the plurality of bristles 108, may be fixed to the end 106 of the handle component 102 by crimping or by glue, etc., or any other suitable securing means as is known in the art.

In one embodiment, the stiff member 112 normally extends outwardly from the handle component 102 a short distance. If a molded plastic handle component 102 is used, the stiff member 112 of the brush component 104 is heated and then pressed into the end 106 of the handle component 102 whereby it will melt the plastic and then solidify by cooling. If a wooden handle component 102 is used, then the brush component 104 may be placed therein and secured with glue or any other securing means as is known in the art to the end 106 of the handle component 102.

Additionally, the bristle portion 110 comprises a plurality of durable bristles 108. The bristles 108 can be manufactured of any suitable material as is known in the art, such as nylon, plastic, hair, etc. The plurality of bristles 108 would be secured to the bristle portion 110 via crimping, gluing, adhesive, etc. The plurality of bristles 108 can be secured to the bristle portion 110 in any desired shape or form, such as a conical shape, a triangular shape, a cylindrical shape, etc., depending on the needs and/or wants of a user and depending on the area needing to be cleaned. The bristle portion 110 is then secured to the stiff member 112 of the brush component 104 via gluing, adhesive, screwing, etc. The brush component 104 is then secured to the handle component 102 via gluing, adhesive, screwing, etc. The brush bristle pattern and array may be comprised of long and/or short bristles, hard and/or soft bristles, in a staggered or straight pattern for use and cleaning of air vents, bead work, fine cracks and lines on dashboards, gauges and the center console.

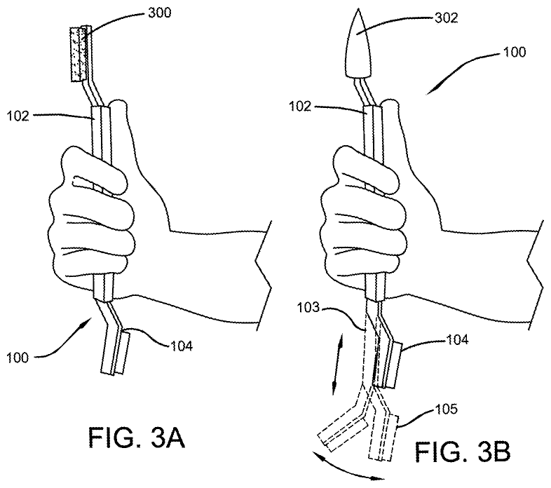

As shown in FIGS. 3A-B, the brush components 104 are releasably secured to the handle component 102, via screws, pins, etc., or any other suitable securing means as is known in the art. Thus, a user can remove and replace the brush components 104 with new brush components 104 when worn out or replace the brush components 104 with additional cleaning implements.

As shown in FIG. 3A, the user can replace a brush component 104 with a foam brush component 300. A foam brush component 300 may be constructed of thermoplastics such as polyurethane foam or styrene or may be constructed of a composite of polyester and polyurethane. It is only important that it be in the form of a foam material for absorbing fluid for the cleaning procedure and be flexible and pliable to conform to the various radii of curvature for various rounded or sharp-edged crevices. Such cleaning brush component 300 is generally conically shaped to taper distally and inwardly from its base toward its reduced in diameter tip. The foam is preferably formed on one lateral side with a generally rounded cross-sectional configuration to form a rounded surface and on the opposite side with a triangular shape terminating in a point to thus cooperate in providing somewhat of a tear drop cross-sectional shape. This facilitates cleaning of rounded openings and crevices by the surface and cleaning of sharper, pointed, or triangular sections by the point.

As shown in FIG. 3B, the user can replace a brush component 104 with a polishing component 302. The polishing component 302 is constructed of absorbent fiber material such as terrycloth, chamois, cotton, etc., and is configured with a generally conical shape to compliment the shape of the brush component 104 and is configured to form a close-fit relationship therewith so as to hold the polishing component 302 in position on the handle component 102 and prevent all around rotation relative to the polishing component 302 during the polishing procedure. Any other suitable brush components 104 can be utilized as is known in the art, depending on the needs and/or wants of a user.

Furthermore, the handle component 102 comprises a telescoping body/handle 103 that can be extended or shortened in length as needed. Specifically, the telescoping body 103 comprises an elongated tubular shaft comprising a plurality of telescoping members which telescope in and out. Further, the telescoping body 103 can be hinged, allowing it to be bent at various angles, as needed. Additionally, the brush component 104 can be an angled brush component 105 and is adjustable and able to be bent at angles, as well. Specifically, the handle component 102 comprises a hollow interior recess for receiving the angled brush component 105, which is insertable into the distal end of the elongated tubular shaft of the telescoping body 103 via a pin connector/fixation to allow for the angled brush component 105 to be positioned in various angles, in regards to the telescoping body 103.

Further, the cleaning brush device 100 of the present invention may be sold individually or in a kit 304 with multiple interchangeable brush head components 104. Any suitable number of brush head components 104 can be utilized as is known in the art. Each brush head component 104 would be utilized for cleaning different surfaces and/or sizes of crevices, openings, and small spaces within the vehicle interior. Each brush head component 104 would be any suitable size and shape as is known in the art.

From the foregoing, it will be apparent to those skilled in the art that the cleaning brush device 100 of the present invention is of relatively inexpensive construction and provides for convenient access to nearly all openings, surfaces, and crevices of vehicle interiors for thorough and complete cleaning and detailing thereof.

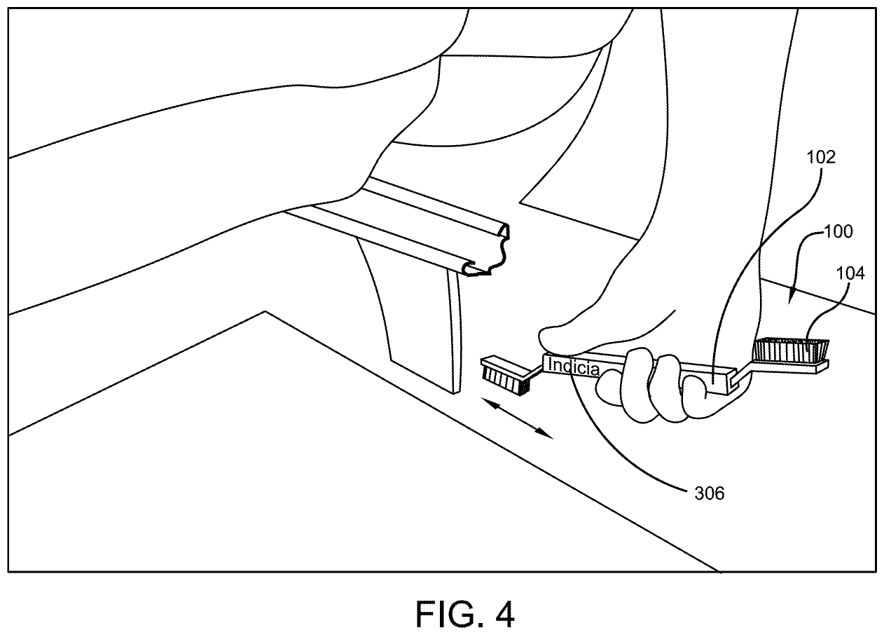

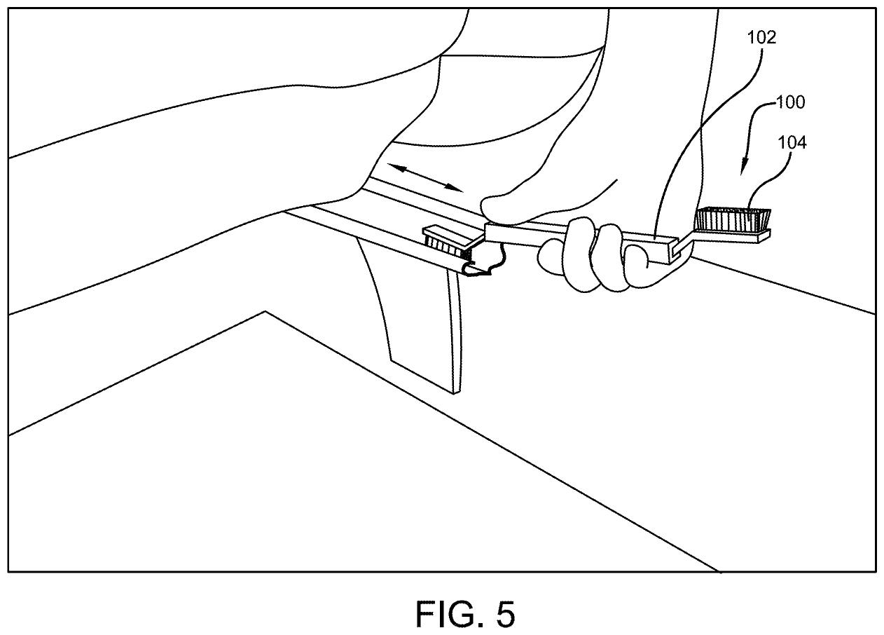

As shown in FIGS. 4-5, the cleaning brush device in use can be utilized to clean all parts of a vehicle interior. The larger of the brush components 104 can be utilized to clean the vehicle's floor surfaces, seat surfaces, interior walls, or other large surface areas within the vehicle (as shown in FIG. 4). The smaller of the brush components 104 can be utilized to clean the crevices between seats, small areas, tight spaces, or other small surface areas within the vehicle (as shown in FIG. 5).

Furthermore, the cleaning brush device 100 comprises a plurality of indicia 306. The handle component 102 of the device 100 may include advertising, a trademark, or other letters, designs, or characters, printed, painted, stamped, or integrated into the handle component 102, or any other indicia 306 as is known in the art. Specifically, any suitable indicia 306 as is known in the art can be included, such as, but not limited to, patterns, logos, emblems, images, symbols, designs, letters, words, characters, animals, advertisements, brands, etc., that may or may not be cleaning or vehicle/brand related. In another embodiment, the handle component 102 may have an opening therein for hanging on a hook, nail or the like.

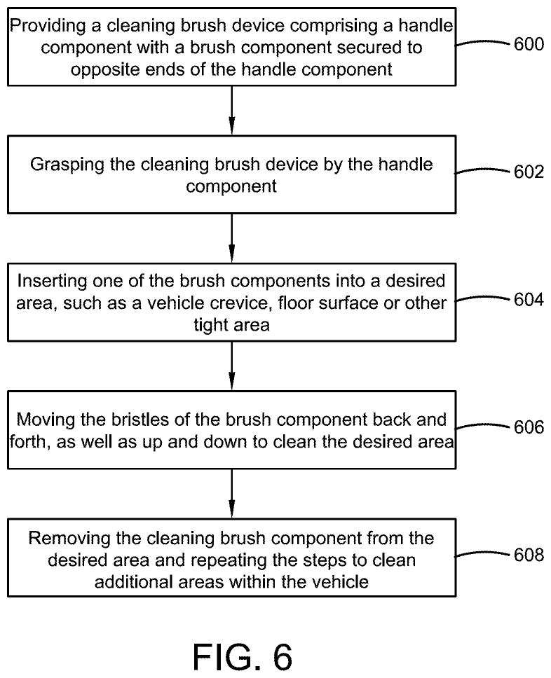

FIG. 6 illustrates a flowchart of the method of cleaning crevices and other hard-to-reach areas within a vehicle. The method includes the steps of at 600, providing a cleaning brush device comprising a handle component with a brush component secured to opposite ends of the handle component. The method also comprises at 602, grasping the cleaning brush device by the handle component, such that the device is securely held in a user's hand. Further, the method comprises at 604, inserting one of the brush components into a desired area, such as a vehicle crevice, floor surface, or other tight area. The method also comprises at 606, moving the bristles of the brush component back and forth, as well as up and down to clean the desired area. Finally, at 608, removing the cleaning brush component from the desired area and repeating the steps to clean additional areas within the vehicle.

Certain terms are used throughout the following description and claims to refer to particular features or components. As one skilled in the art will appreciate, different users may refer to the same feature or component by different names. This document does not intend to distinguish between components or features that differ in name but not structure or function. As used herein “cleaning brush device” and “device” are interchangeable and refer to the cleaning brush device 100 of the present invention.

Notwithstanding the foregoing, the cleaning brush device 100 of the present invention can be of any suitable size and configuration as is known in the art without affecting the overall concept of the invention, provided that it accomplishes the above-stated objectives. One of ordinary skill in the art will appreciate that the cleaning brush device 100 as shown in FIGS. 1-6 are for illustrative purposes only, and that many other sizes and shapes of the cleaning brush device 100 are well within the scope of the present disclosure. Although the dimensions of the cleaning brush device 100 are important design parameters for user convenience, the cleaning brush device 100 may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A cleaning brush device for effectively removing dirt and dust from crevices, floors and other tight spaces within a vehicle interior, the cleaning brush device comprising:
a handle component; and
a pair of brush components;
wherein a select one of the pair of brush components is secured to an end of the handle component;
wherein another of the pair of brush components is secured to an opposite end of the handle component; and
further wherein each of the pair of brush components comprise a bristle portion with a plurality of bristles.

2. The cleaning brush device of claim 1, wherein the pair of brush components comprise a stiff member.

3. The cleaning brush device of claim 2, wherein the stiff member comprises a coil spring that is tightly wound into a small diameter.

4. The cleaning brush device of claim 3, wherein the stiff member comprises a rigid member which extends axially within the coil spring.

5. The cleaning brush device of claim 2, wherein the stiff member comprises a twisted pair of wires.

6. The cleaning brush device of claim 2, wherein the stiff member comprises a metal component.

7. The cleaning brush device of claim 2, wherein the handle component is manufactured of plastic and the brush component is heated and pressed into an end of the handle component to secure the brush component.

8. The cleaning brush device of claim 2, wherein the handle component is manufactured of wood and the brush component is glued into an end of the handle component to secure the brush component.

9. The cleaning brush device of claim 1, wherein the plurality of bristles are secured to the bristle portion in any desired shape.

10. The cleaning brush device of claim 1, wherein the pair of brush components are releasably secured to the handle component, such that the pair of brush components can be removed and replaced.

11. The cleaning brush device of claim 10, wherein a brush component can be a foam brush component.

12. The cleaning brush device of claim 10, wherein a brush component can be a polishing component.

13. The cleaning brush device of claim 10, wherein the cleaning brush device is sold as a kit with multiple interchangeable brush components.

14. A cleaning brush device for effectively removing dirt and dust from crevices, floors and other tight spaces within a vehicle interior, the cleaning brush device comprising:
a telescoping handle component; and
a pair of angled brush components;
wherein a select one of the pair of angled brush components is secured to an end of the telescoping handle component;
wherein another of the pair of angled brush components is secured to an opposite end of the telescoping handle component; and
wherein each of the pair of angled brush components comprise a bristle portion with a plurality of durable bristles; and
further wherein the telescoping brush component comprises a stiff member, which is a coil spring that is tightly wound into a small diameter with a rigid member which extends axially within the coil spring.

15. The cleaning brush device of claim 14 further comprising a plurality of indicia.

16. The cleaning brush device of claim 14, wherein the pair of angled brush components are releasably secured to the telescoping handle component, such that the pair of angled brush components can be removed and replaced.

17. The cleaning brush device of claim 16, wherein an angled brush component is a foam brush component.

18. The cleaning brush device of claim 16, wherein an angled brush component is a polishing component.

19. The cleaning brush device of claim 16, wherein the cleaning brush device is sold as a kit with multiple interchangeable angled brush components.

20. A method of cleaning crevices and other hard-to-reach areas within a vehicle, the method comprising the steps of:
providing a cleaning brush device comprising a handle component with a brush component secured to opposite ends of the handle component;
grasping the cleaning brush device by the handle component, such that the device is securely held in a user's hand;
inserting one of the brush components into a desired area, such as a vehicle crevice, floor surface, or other tight area;
moving the bristles of the brush component back and forth, as well as up and down to clean the desired area; and
removing the cleaning brush component from the desired area and repeating the steps to clean additional areas within the vehicle.
